(19) United States
(12) Patent Application Publication
(10) Pub. No.: US 2004/0031155 A1
(43) Pub. Date: Feb. 19, 2004

(54) Side opening knife

(76) Inventors: Thomas Henry Hitchcock, Watsonville, CA (US); Edward Tate Van Hoy, Candor, NC (US)

Correspondence Address: Thomas Henrey Hitchcock, 445 Summit Rd, WATSONVILLE, CA, 95076, US

(21) Appl. No.: 10/456,670

(22) Filed: Jun. 5, 2003

Related U.S. Application Data
(60) Provisional application No. 60/386,443, filed on Jun. 7, 2002.

(51) Int. Cl. B26B 3/06

(52) U.S. Cl. 30/161

(57) ABSTRACT

The current invention addresses these issues in a simple yet effective way. The engagement between the blade and handle is extremely strong when locked, yet can be easily moved with the tip of a finger when the actuating means is engaged. Thus the blade is held rigidly in both the open and closed positions by the interlock and is easily changed in an ergonomically intuitive flick of one finger. The preferred method is to use a cam or cams to rotate against the frame, pivoting near the center of the blade, perpendicular to the axis of blade rotation. Thus the entire knife is composed of three primary parts: the blade, the frame and the cam. No additional springs are needed to effect the mechanism. Another desired feature is an integrated lanyard clip which is designed into the interface of the cam and blade surfaces. This clip is located in a way that allows the user to “pluck” the knife from a ring or lanyard. A belt clip can also be affixed to the u shaped member. This would allow an alternative means of securing the knife for ease of storage.

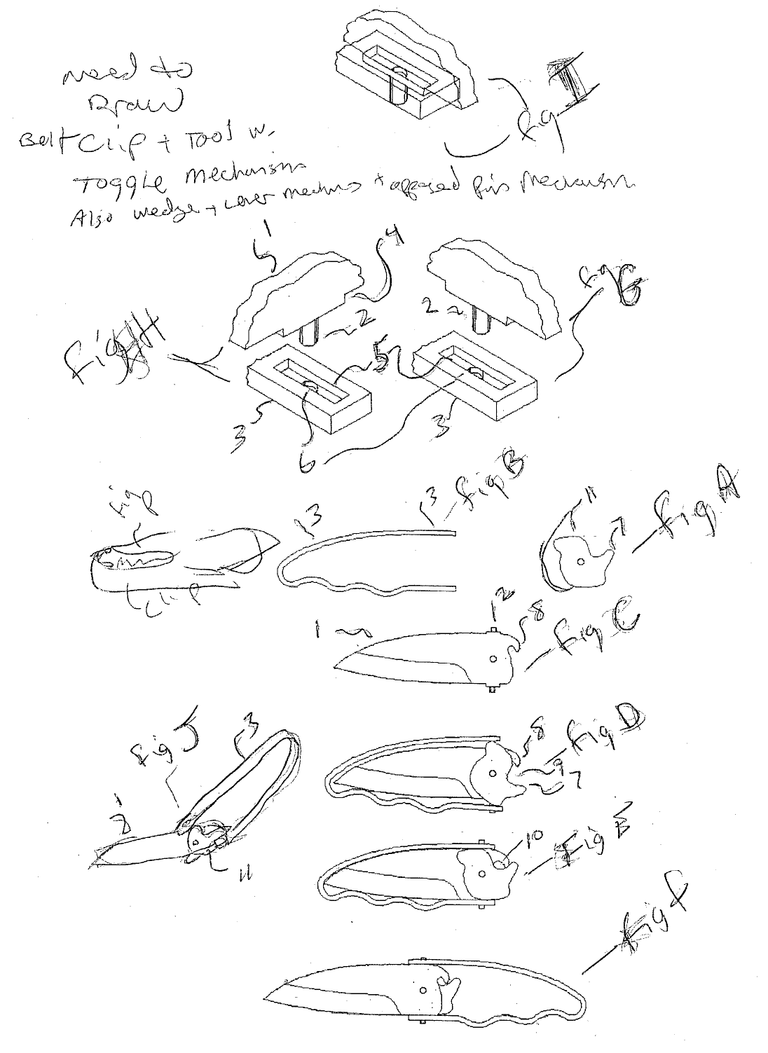

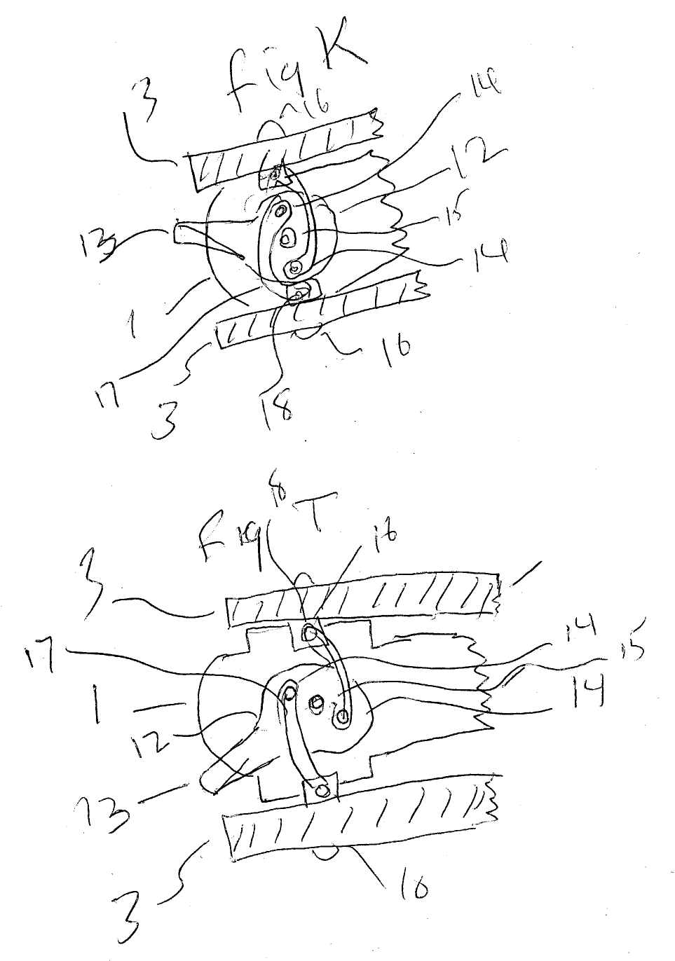

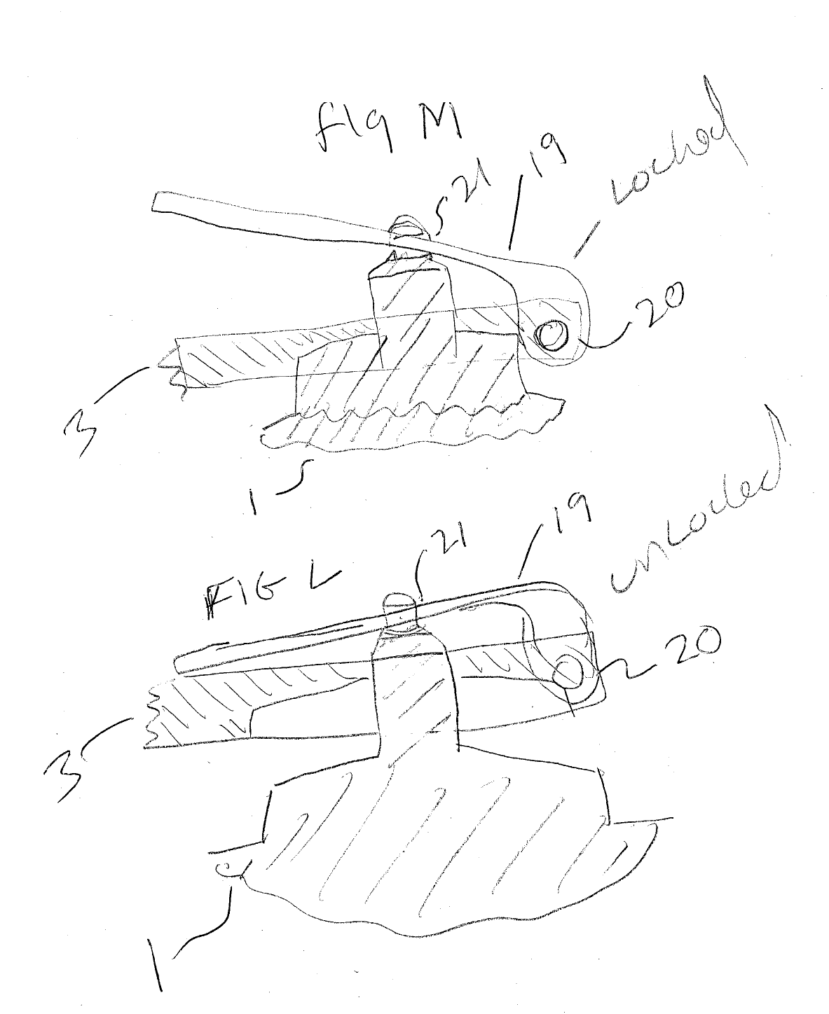

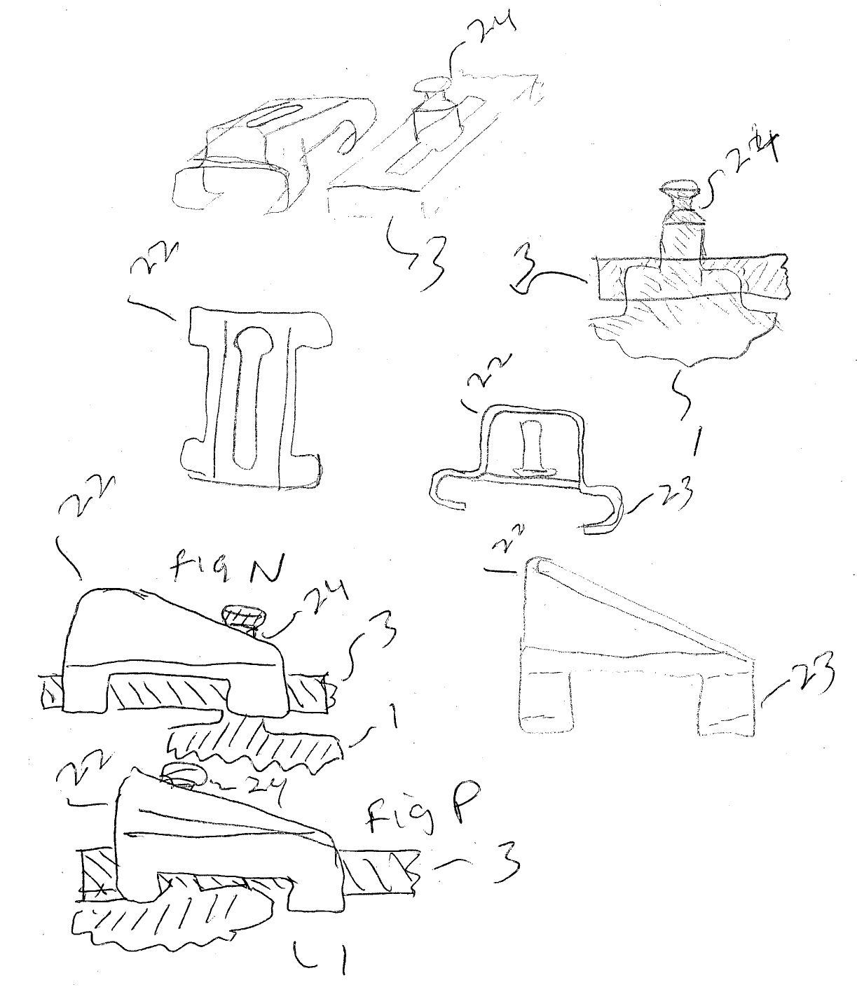

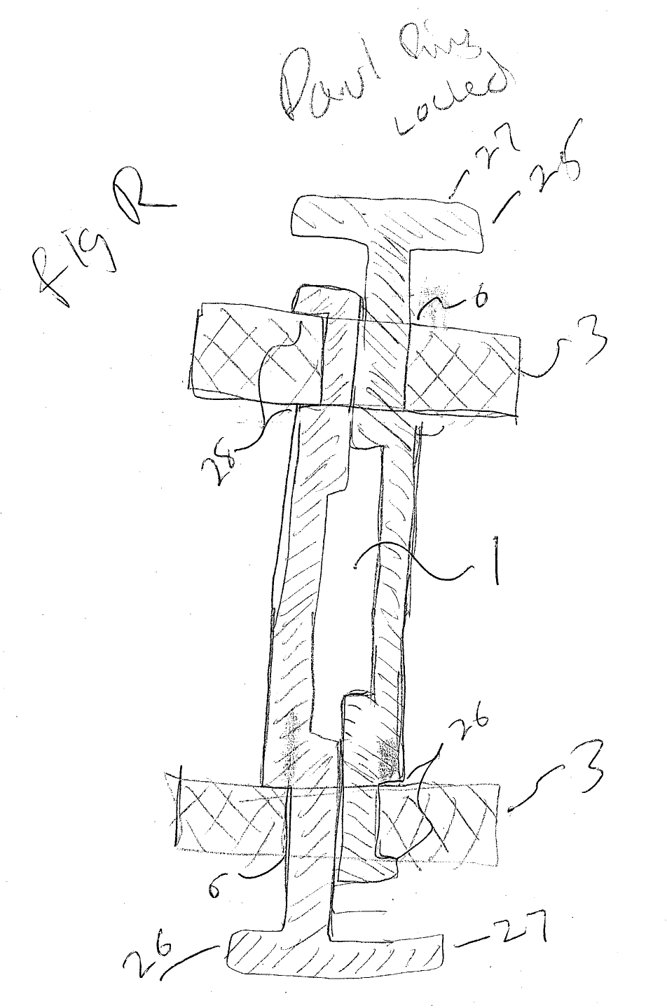

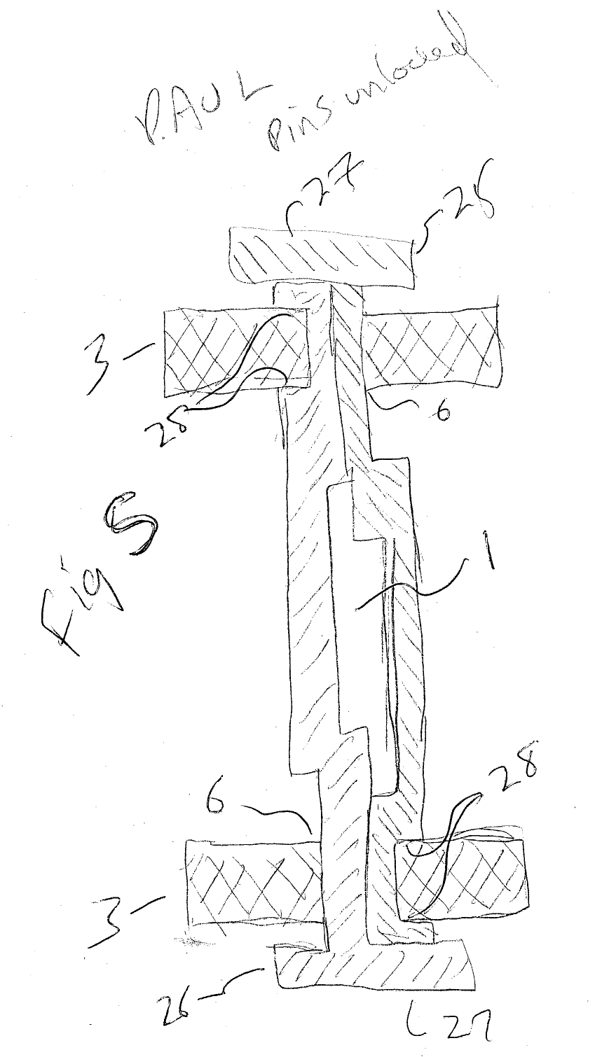

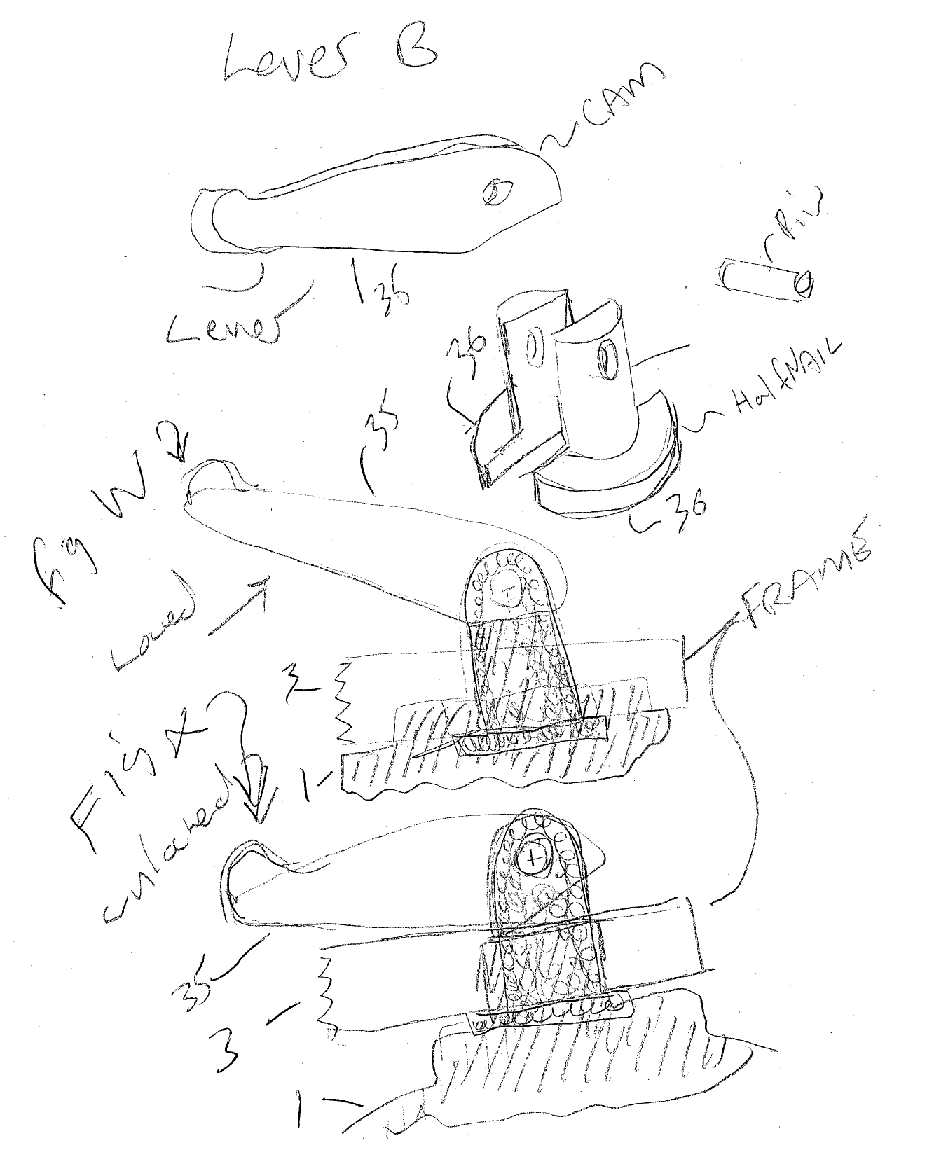

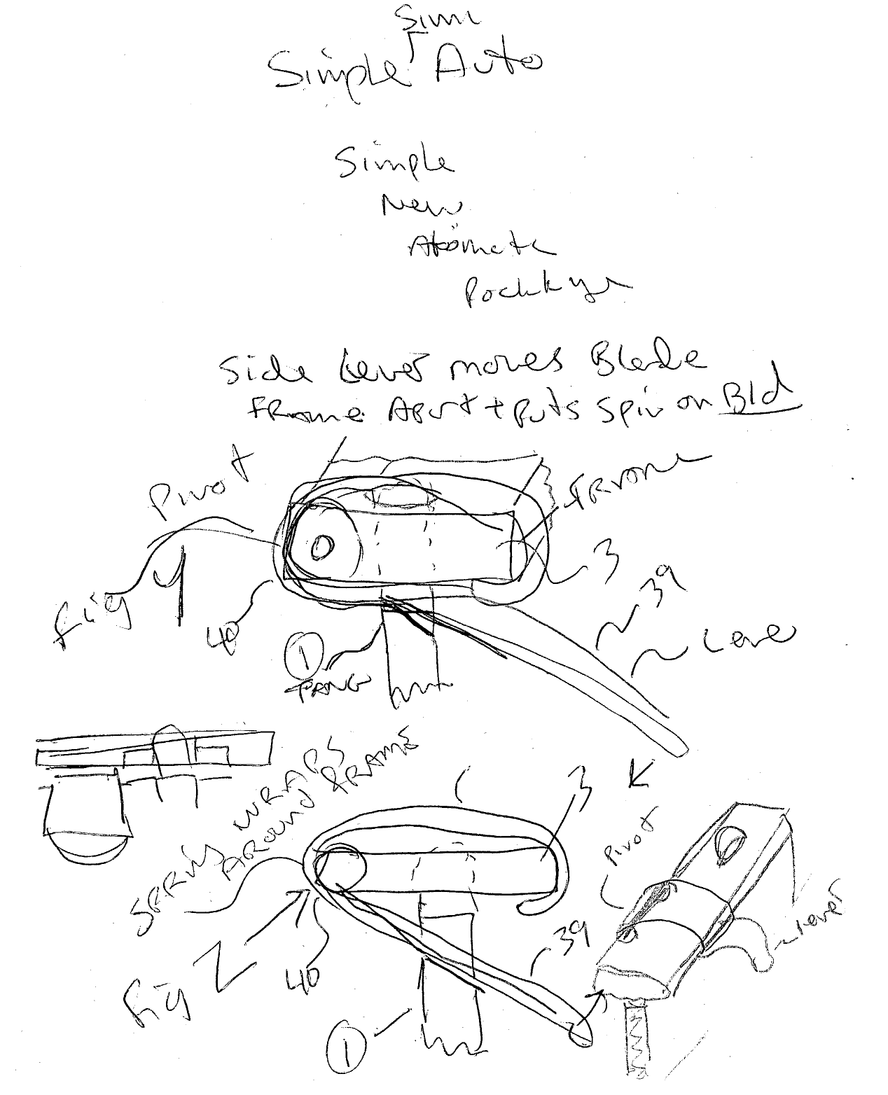

### CROSS-REFERENCE TO RELATED APPLICATIONS

provisional patent No. 60/386,443,

### BACKGROUND OF THE INVENTION

1. Description

The object of the invention is to provide a serviceable folding knife which opens sidewardly, pivoting about an axis passing through the edges of the blade rather than the conventional pivot method passing through the flat faces of the blade. The advantage of the present invention is to provide a knife which is light, ergonomic, compact, locking open and closed, and easily operated with one hand. Other features include both an integral lanyard clip and a belt clip.

The current knife is based on 3 primary elements operating together. These are: the frame, the blade, and the interlock actuating mechanism.

The frame is a “u” shaped piece of resilient material with holes disposed at each end of the “u”. These holes accept the pivots. The “u” ends also have rectangular openings to engage profiles on the blade providing an interlock. The “u” is formed such that it generally conforms to the blade profile and the holes at the ends are in axial alignment with each other. The frame is also proportioned such that the blade nests within the curved profile and the tang of the blade presents a means of providing pivots so as to rotate into and out of the nested and extended positions. An actuating means, typically a cam or cams, moves to displace the frame ends, thus releasing the interlock and allowing the tool element to rotate freely to the desired position. When the tool fully extends or retracts, the interlock engages and the resilient force of the frame closes the interlock, and rotates the cam to a normal position.

2. Prior Art

Side opening knives have been in existence for centuries but generally have not gained mass acceptance. The inventors believe that this has to do with several design problems which have not been adequately addressed. The main problem being how to, move the blade from the opened to closed position and back while still maintaining both a positive lock and ease of use. Several strategies have been employed to accomplish this. A number of knives (though files and other tool elements employ these mechanisms as well) use the frame member as a spring to engage detent surfaces which match mating surfaces on the blade. The Collins knife is a good example of this though this mechanism has existed long before. The primary disadvantage is that the amount of force required to release the blade from the locked position is the same whether the user desires it or not. Thus the same amount of force holding the blade open against accidental closure needs to be overcome to effect intentional closure. This is not good design and can be inherently dangerous. Ideally the blade should be locked open or closed until it is intentionally changed by a small force applied by the user. This can be seen in a conventional knife such as a liner lock, where small forces are exerted by the user to change blade positions yet a large force would be needed if the liner is not moved aside. The Ross knife best overcomes these problems, yet it requires a less elegant means of spreading the u element and rotating the blade. The Mearns knife overcomes this problem by adding an additional spring latch element between the frame and tang. This provides a strong yet releasable lock but it is not ergonomically easy to actuate.

### BRIEF SUMMARY OF THE INVENTION

The current invention addresses these issues in a simple yet effective way. The engagement between the blade and handle is extremely strong when locked, yet can be easily moved with the tip of a finger when the actuating means is engaged. Thus the blade is held rigidly in both the open and closed positions by the interlock and is easily changed in an ergonomically intuitive flick of one finger. The preferred method is to use a cam or cams to rotate against the frame, pivoting near the center of the blade, perpendicular to the axis of blade rotation. Thus the entire knife is composed of three primary parts: the blade, the frame and the cam. No additional springs are needed to effect the mechanism. Another desired feature is an integrated lanyard clip which is designed into the interface of the cam and blade surfaces. This clip is located in a way that allows the user to “pluck” the knife from a ring or lanyard. A belt clip can also be affixed to the u shaped member. This would allow an alternative means of securing the knife for ease of storage.

### BRIEF DESCRIPTION OF THE SEVERAL VIEWS OF THE DRAWING

Drawings:

Fig A depicts the cam

Fig B depicts the frame

Fig C depicts the tool element

Fig D depicts the the knife with the cam rotated, and the frame spread away from the blade. The interlock is disengaged just prior to rotating the blade relative to the frame.

Fig E depicts the knife with the cam in the normal position, the interlock is engaged, with the blade locked rotationally relative to the frame.

Fig F depicts the the blade extended relative to the frame with the cam in the normal position.

Fig G depicts an exploded orthogonal cut away view of the interlocking mechanism between the blade and frame, with the interlocking parts normal to each other as in the locked position.

Fig H depicts an exploded orthogonal cut away view of the interlocking mechanism between the blade and frame, with the parts rotated as when the knife is being opened or closed.

Fig I depicts an orthogonal cut away view of the interlocking mechanism between the blade and frame, with the parts nested in the locked position

Fig J depicts an orthogonal view of the knife being opened or closed.

Fig. K depicts an alternative mechanism for operating the interlock featuring a toggle linkage

Fig. L depicts an alternative mechanism for operating the interlock featuring a lever pivoting on the end of the u member against the pivot pin with the lever depressed and the interlock released.

Fig. M depicts an alternative mechanism for operating the interlock featuring a lever pivoting on the end of the u member against the pivot pin with the lever released and the interlock engaged.

Fig. N depicts an alternative mechanism for operating the interlock featuring a sliding wedge on the end of the u member acting against the pivot pin, with the interlock released.

Fig. P depicts an alternative mechanism for operating the interlock featuring a sliding wedge on the end of the u member acting against the pivot pin with the interlock engaged.

Fig. R depicts an alternative mechanism for operating the interlock featuring a pair of opposing pins in an undepressed state with the interlock engaged.

Fig. S depicts an alternative mechanism for operating the interlock featuring a pair of opposing pins in a depressed state with the interlock disengaged.

Fig. T depicts the toggle linkage mechanism with the interlock disengaged

Fig. V depicts a belt clip means attached to the u shaped frame element

Fig. W depicts a lever with cam means for activating the interlock, interlock engaged

Fig. X depicts a lever with cam means for activating the interlock, interlock released.

Fig. Y depicts a interlock release means featuring a side pivoting lever, interlock engaged

Fig. Z depicts a interlock release means featuring a side pivoting lever, interlock released

numeral 1 depicts the blade

numeral 2 depicts the pivot pin formed on the blade

numeral 3 depicts the the frame

numeral 4 depicts the raised interlock section of the blade

numeral 5 depicts the recessed interlock section of the frame end

numeral 6 depicts the hole which receives the pin (2).

numeral 7 depicts the protrusion area of the cam

numeral 8 depicts the clip interface area of the blade

numeral 9 depicts the clip interface in the open position

numeral 10 depicts the clip interface in the closed position

numeral 11 depicts the cam

numeral 12 depicts the rotator plate

numeral 13 depicts the the finger actuating protrusion of the rotator plate

numeral 14 depicts the depict the toggling pivot points on the rotator plate

numeral 15 depicts the central pivot point on the rotator plate

numeral 16 depicts the pivot pin actuated by the linkage

numeral 17 depicts the links

numeral 18 depicts the pivot point of the links

numeral 19 depicts the lever

numeral 20 depicts the pivot point of the lever and u member end

numeral 21 depicts the pivot point of the lever and pivot of the tang

numeral 22 depicts the depicts the sliding wedge

numeral 23 depicts the the area of the wedge formed to slideably engage the u member end

numeral 24 depicts the interface of the wedge and the pivot pin

numeral 25 depicts one of two identical split pins

numeral 26 depicts the other pin

numeral 27 depicts the finger depressing area of the pins

numeral 28 depicts the area of the pins which engage the u member

numeral 29 depicts the belt clip as part of the knife

numeral 35 depicts the lever cam

numeral 36 depicts the half nail device

numeral 39 depicts the side opening lever

numeral 40 depicts the flexing area of the side opening lever

### DETAILED DESCRIPTION OF THE INVENTION

The tool is comprised of three primary elements: a blade with intrinsic tang (Fig C, #1), a “u” shaped member or frame (Fig B & #3) and a release/lock means (Fig C, #2). The blade (#1) is nested in the u member (#3) and pivots (#2,6) form an axle allowing rotation (Fig J) to an extended state (Fig F). The third element the cam (Fig A) allows the user to release the interlock Figs (G, H, & I, #3) by applying force to the protrusion (#7) This overcomes the resilience of the u member (#3) as the cam surfaces (#11) displace the ends of the u member (Fig D). When the interlock is released (Fig H) the blade is free to rotate about the pivots (#2). The user now moves the blade about the axis using the same protrusion that released the lock (#7). The blade is now rotating from the nested position to the extended position (Fig J). When the rotation is complete the interlock aligns and the blade catches and stops (Fig F). The u member by its resilience causes the interlock to close (Fig I) and the cam to rotate to the normal position. Returning the blade to the nested position requires simply reversing the sequence just described.

Optional Methods Contemplated:

Toggle linkage method (Fig K) uses links (#14) which move rotationally relative to the pivot pins and slideably relative to the blade. In this mechanism the ends of the u member (#3) are moved apart by a rotating plate (#12) which has pivot pins (#14) which are aligned with the axis of rotation when the interlock is closed (Fig K). rotating the plate causes the pins to move towards the opposite edge of the tang (Fig T). Links (#17) connected to the pivots on the plate connect to pivots (#15) slideably connected to the edges of the tang (#1). This can be accomplished through the pivots by means of pins (#16) perpendicular to the axis of rotation or by having a slot in the tang which guides the links to engage the ends of the u shaped frame element (#3).

Another embodiment utilizes interlocks controlled by levers outside the frame (Fig L & M). This mechanism has the levers (#19) which pivot on the u shaped frame element (#3) at (#19) and translate force from the users fingers to the pivots (#21) thus disengaging the interlock. The lever (#18) pivots on the u member at (#19) and drives the u shaped frame element (#3) away from the tang (#1) at point (#20). Releasing the lever allows the interlock to close.

Another method (Figs N & P) would use wedge action between the frame and the blade. Both of the methods employ pivots (#24) which extend beyond the outward edges of the “U” member (#3). The wedge (#22) is slideably affixed to the end of the u shaped frame element (#3) and has a sloped means of engaging the pivot pin. When the wedge member is moved in one direction the interlock is force closed (Fig P) and moving the wedge in the opposite direction causes the interlock to open (Figs N).

Another means for displacing the interlock (Figs R & S) is to provide long split pins (#25 & 26) between the blade (#1) and the u member (#3) Each pin extends beyond the frame through holes in the u shaped frame element (#6). Each pin engages one of the holes in the u shaped frame element (#28) with its opposite end extending through the opposite hole in the u shaped frame element (#27). These areas provide a means of pressing the pins toward each other. Thus pressing the extending pins causes the ends of the u shaped frame element ends (#3) to disengage from the tang interlock (Fig. S) The pin ends can be used to effect the opening of the blade by applying rotational force. This is similar to a “Paul” mechanism but the axis of rotation is about the edge of the tang instead of on the flat edge.

The knife as designed has an intrinsic lanyard clip function (#10) wherein the protrusion (#7) of the cam engages the protrusion of the tang (#8) and forms a circular enclosure. This tends to remaining closed because of the rotational force directed to the cam (Fig. A) by the resilient force of the u shaped frame member. Releasing of the clip is effected by rotating the cam and overcoming the spring force of the u shaped member (#3).

An alternate means (Figs. W & X) of effecting the interface is to provide devices which penetrate the u members rounded openings adjacent to the tang pivot means. These devices have a flange which engages the inner face of the u member (#3), the opposite end of these devices have a pivot point perpendicular to the first axis and above the outer edge of the frame member. These pivots engage a lever (#35) with an integral cam surface. The cam surface engages the top of the pivot such that rotating the lever applies a force between the half nail devices and the top of the tang pivot. This motion allows the interlock to be released (Fig. X). When the lever is depressed it can then be used to rotate the blade to the opposite position (Fig. W).

An alternative means of actuating the interlock (Figs. Y & Z) uses a side opening lever (#39) flexing at point (#40). The lever has the function of both prying the frame (#3) away from the tang (#1), and also imparting a biased rotational force on the tang, such that when the interlock is released (Fig. H), the blade automatically revolves around the pivot point.

All designs have been described as using both edges of blade/u shaped frame element as interlock interfaces but all means described can also be employed on only one of the interfaces to effect the interlock mechanism. In such a design the edge of the tang opposite the interface would provide a simple rotational pivot with no interlock to overcome.

Figure v depicts a typical belt clip #28 attached to the u shaped frame element #3

What is claimed:

1 a u shaped frame made of resilient material with axially aligned holes at each end; a tool element disposed pivotally between the ends of said frame; an axle means disposed between said frame holes and said tool element, a means provided for said frame and said tool element to interlock with each other in a desired rotational alignment, said interlock means being accomplished by conforming shapes in said frame and said tang, said interlock being accomplished by the engagement of said frame relative to said tang, the release of said engagement being accomplished by an activating means which moves the end of said frame away from said tang, said activating means enabling the interlock to be engaged and disengaged, said interlock can be rotationally or slideably disposed relative to said frame ends and said tool element said, activating means having a means engageable an external force.

2 a u shaped frame element made of a resilient material with opposing openings disposed at either end; said openings having a rounded area to recieve pivot elements and rectangular openings disposed to engage raised portions on a tool element; said tool element with a blade end and a tang end, said tang end being pivotally disposed between said opposing openings; said pivoting being accomplished by pivot devices positioned between said frame and said tang, said pivot devices being designed to enable controlled rotating and linear motions, said pivots enabling two states; first is said tang pivoting around said frame; the second state is the interlock between said frame and said tang, where recessed rectangular areas in said frame match raised sections in said tang, these recessed rectangular areas are symmetrical to allow two rotational positions of said tang/frame interlock; a cam method for changing the pivot states, said cam having a protrusion for translating a small applied force into rotational movement about an axis near the center of said tang which moves the cam faces so that they move the pivot pins by means of engagement means disposed perpendicular to the axis of and intrinsic with said first pivot devices; the said pivots are moved slideably apart releasing the interlock between said tang and said u element, the cam operating surface is actuated when said force is removed, said resilient u element drives the said pivots toward each other which drives the cam, this action occurs when the tool is in either extended or retracted position.

3 a u shaped frame element made of a resilient material with opposing rounded openings axially disposed at either end; a tool element with a blade end and a tang end; said tang end being pivotally disposed between said opposing frame openings; such that said blade element can be nested within said frame or pivotally extended, said pivoting being accomplished by pivot means incorporated with said tang, said pivot means being designed to enable controlled rotational and linear motions between said tool element and said frame, enabling two states; first is blade pivoting around frame, the second state is the interlock between said frame end and said tang where recessed rectangular areas in said frame end match raised sections in said tang, these recessed rectangular areas are symmetrical to allow two interlock positions, fully extended and retracted; a cam rotatably disposed perpendicular to said tool element, said cam having a protrusion for translating an applied force into rotational movement about an axis, said cam having a surface which slideably engages the face of said frame end near said opposing opening, rotation of said cam causing the displacement of said frame end away from said tang, effecting the release of said interlock between said tool element and said frame end, enabling said tang element to be rotated relative to said frame, upon reaching a rotation of 180°, said interlock aligns allowing said frame and said tool element to reengage while returning said cam to its initial unrotated position.

4 a u shaped frame element made of a resilient material with opposing openings disposed at either end; said openings having a rounded area to receive pivot elements and recessed rectangular areas; a tool element with a blade end and a tang end said tang end being pivotally disposed between said opposing openings; said pivoting being accomplished by pivots intrinsic with said tang said pivot devices extending through said u shaped member end and being designed to enable controlled rotating and linear motions of said pivots, said pivots enabling two states; first is blade pivoting around frame; the second state is the engageable interlock between said frame and tang blade where recessed rectangular areas in said frame ends match raised sections in the tang, these recessed rectangular areas are symmetrical to allow two rotational positions of said tang; a lever pivotally mounted to the end of said u shaped frame, said lever having a rotational engagement of said pivot means, said lever having an extension engageable with a finger.

5 a u shaped frame element made of a resilient material with opposing openings disposed at either end; said openings having a rounded area to receive pivot elements and recessed rectangular areas disposed to engage raised portions on blade element; a tool element with a blade end and a tang end said tang end being pivotally disposed between said opposing openings; said pivoting being accomplished by pivots intrinsic with said tang, said pivot extending through said u shaped member end and being designed to enable controlled rotating and linear motions, said pivots enabling two states; first is blade pivoting around frame in 180° or 360° rotation; the second state is the interlock between frame and blade where holes in the frame match raised sections in the tang these holes are symmetrical to allow two rotational positions of the tang; a wedge element slideably disposed on said u shaped element, said wedge engaging said pivot element and positioning said pivot element in two states one with the interlock engaged and one with the interlock released.

6 a u shaped frame element made of a resilient material with opposing openings disposed at either end; said openings having a rounded area to receive pivot elements and recessed rectangular areas disposed to engage raised portions on a tool element; said tool element with a blade end and a tang end said tang end being pivotally disposed between said opposing openings; said pivoting being accomplished by split pivot pins, said pivot pins extending through both rounded openings of said u shaped member end and being designed to enable controlled rotating and linear motions relative to said tool element and said u shaped member, said pins having an engagement means on one end to move said u shaped member away from said tang when said pivot pin is depressed on its extreme opposite end, said pivots enabling two states; depressing the pins allows rotation of said blade about said u shaped member; the second state when said pins are released allows the interlock between frame and blade, where recessed rectangular areas in the frame match raised sections in the tang, said rectangular openings are symmetrical to allow two rotational positions of the tang, one with said blade extended one with said blade nested within said u shaped frame element.

7 a u shaped frame element made of a resilient material with opposing openings disposed at either end; said openings having a rounded area to receive pivot elements and recessed rectangular areas; a tool element with a blade end and a tang end said tang end being pivotally disposed between said opposing openings; said pivoting being accomplished by pivots intrinsic with said tang said pivot devices extending through said u shaped member end and being designed to enable controlled rotating and linear motions of said pivots, said pivots enabling two states; first is blade pivoting around frame; the second state is the engageable interlock between said frame and tang blade where recessed rectangular areas in said frame ends match raised sections in the tang, these recessed rectangular areas are symmetrical to allow two rotational positions of said tang; a device which passes through said frame end and engages the surface of said frame end facing the opposite end, said device having at its end opposite the first said end a pivot means perpendicular to the axis of said openings, a lever pivotally mounted to the end of said pivot, said lever having a rotational engagement of said pivot means, said lever having a cam means for engaging the end of said tang pivot means, such that depressing the lever moves said tang away from said u member and releasing the interlock, said lever having an extension engageable with a finger.

8 a u shaped frame element made of a resilient material with opposing openings disposed at either end; said openings having a rounded area to receive pivot elements and recessed rectangular areas; a tool element with a blade end and a tang end said tang end being pivotally disposed between said opposing openings; said pivoting being accomplished by pivots intrinsic with said tang said pivot devices extending through said u shaped member end and being designed to enable controlled rotating and linear motions of said pivots, said pivots enabling two states; first is blade pivoting around frame; the second state is the engageable interlock between said frame and tang blade where recessed rectangular areas in said frame ends match raised sections in the tang, these recessed rectangular areas are symmetrical to allow two rotational positions of said tang; a lever which passes across said frame end and flexibly or pivotally engages the surface of said frame edge adjacent to the interlock area, said device having at its end opposite the first said end an actuating means, said lever having a flexible or pivotal engagement of said actuating means, said lever having a cam means for engaging the edge of said tang, such that depressing the lever moves said tang away from said u member and releasing the interlock, said lever having an extension engageable with a finger.

9 a tool of claims 1, 2, 3, 4, 5, 6, 7 & 8 wherein the actuating means engages both ends of said u shaped frame element.

10 a tool of claims 1, 2, 3, 4, 5, 6, 7 & 8 wherein the actuating means engages one end of said u shaped frame element, the opposite end being a simple pivot.

11 A tool of claims 2, 3 & 4 which comprises a curved surface on said cam element adjacent to said protrusion on said cam, a second curve formed on said tang opposite the blade end, said first and second curves forming an enclosure that forms a clip opening between the cam curve and said tool element tang curve when said interlock is closed, said clip being held closed by the resilience of said u shaped frame rotatably engaging said cam, said clip being opened by rotation of said cam.

12 A knife of claims 1, 2, 3, 4, 5, 6, 7 & 8 where a resilient second element is conjoined or formed to said u shaped second element on the surface opposite the open end, said resilient second element disposed towards the open end of said u element, said resilient second element laying adjacent to said blade element and forming a clasp for material such as a pocket edge.

13 A tool of claim 1, 2, 3, 4, 5, 6, 7 & 8 wherein the interlock of said tang and said openings of said u shaped element may have some asymmetry to allow different degrees of interlock in opened and retracted positions of the tang.
